(19) United States
(12) Patent Application Publication
(10) Pub. No.: US 2007/0070160 A1
(43) Pub. Date: Mar. 29, 2007

(54) Coloring composition and inkjet recording ink composition

(75) Inventors: Masaru Takasaki, Minami-Ashigara-shi (JP); Yoshihiko Fujie, Minami-Ashigara-shi (JP); Yoshihiro Jimbo, Minami-Ashigara-shi (JP); Naoki Saito, Fujinomiya-shi (JP); Yoshimitsu Arai, Fujinomiya-shi (JP); Hisato Nagase, Fujinomiya-shi (JP)

Correspondence Address: BUCHANAN, INGERSOLL & ROONEY PC, POST OFFICE BOX 1404, ALEXANDRIA, VA, 22313-1404, US

(73) Assignee: Fuji Photo Film Co., Ltd., Minami-Ashigara-shi (JP)

(21) Appl. No.: 11/526,821

(22) Filed: Sep. 26, 2006

(30) Foreign Application Priority Data
Sep. 26, 2005 (JP) 2005-277508

(51) Int. Cl. G01D 11/00; C09D 11/00; C09D 11/02

(52) U.S. Cl. 347/100; 106/31.27; 106/31.43; 106/31.46; 106/31.48; 106/31.5

(57) ABSTRACT

A coloring composition comprising a dye compound represented by formula (I): 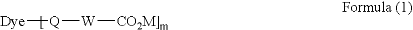
wherein Dye represents a dye structure portion; Q represents —SO—, —SO₂—, —SO₂NR₁₁—, —CO— or —CONR₁₂— in which R₁₁ and R₁₂ each independently represents a hydrogen atom or a substituent; W represents a divalent aliphatic group; M represents an ionic group; and m represents an integer of 1 or greater, and wherein the dye compound satisfies conditions 1 and 2:

Condition 1: 200<Mw/(the number of CO₂M groups contained in the dye compound)<500

Condition 2: (the number of CO₂M groups contained in the dye compound)/p>0.5, with the proviso that Mw represents a molecular weight of the dye compound represented by the formula (1); and p represents the total number of ionic hydrophilic groups substituted on the dye compound represented by the formula (1).

### BACKGROUND OF THE INVENTION

1. Field of the Invention

The present invention relates to a coloring composition containing a novel dye compound, particularly to, an inkjet recording ink composition having ozone resistance, exhibiting a good fixing property to a receiver material even under high humidity conditions and undergoing a small hue change.

2. Description of the Related Art

In recent years, image recording materials for the formation of color images have prevailed particularly as image recording materials. More specifically, inkjet system recording materials, thermal transfer type image recording materials, recording materials employing electrophotography, transfer type silver halide photosensitive materials, printing inks, recording pens, and the like have been used widely. Moreover, in LCD and PDP as displays and in image pickup devices such as CCD in picture-taking instruments, color filters have been employed.

In these color image recording materials and color filters, coloring matters (dyes or pigments) of three primary colors for so-called additive color mixing or subtractive color mixing are employed for reproducing or recording full-color images. Coloring matters which have absorption properties permitting realization of a preferable color reproduction range and are fast enough to endure various using conditions have not yet been developed.

Of various recording methods, inkjet recording method has rapidly come into wide use and is now making further progress because of a low material cost, capability of high-speed recording, less noise during recording, and ease in color recording.

Inkjet recording methods include a continuous method in which liquid droplets are jetted continuously and an on-demand method in which liquid droplets are jetted depending on signals of image information. The liquid droplets are ejected by a method of applying a pressure from a piezoelectric element, a method of generating bubbles in the ink by heat, a method of using ultrasonic waves, and a method of sucking and jetting liquid droplets by electrostatic force. As the inkjet recording ink, aqueous ink, oil-based ink, and solid (fusion-type) ink are used.

The coloring matter to be added to such an inkjet recording ink is required to have good solubility or dispersibility in a solvent, capability of high-density recording, good hue, fastness to light, heat and active gases (oxidizing gases such as NOₓ and ozone, SOₓ, etc.) in the environment, excellent fastness to water and chemicals, good fixing property to a receiver material without bleeding, excellent storage stability as ink, no toxicity, high purity, and availability at a low cost.

It is however extremely difficult to obtain coloring matters capable of satisfying these requirements without reducing their levels. In particular, there is a strong demand for coloring matters having a good magenta hue and exhibiting fastness to light and active gases in the environment, particularly, fastness to oxidizing gases such as ozone.

Many inkjet printers form a multicolor image or document by dispersing coloring inks (for example, black ink, cyan ink, magenta ink and yellow ink) which are different from each other on a base material to be printed. For example, a color image may have some different regions formed using different coloring inks. When an image or document thus printed is placed under high humidity conditions, however, a coloring ink (first ink) in one region may transfer laterally to an adjacent region and be mixed with another coloring ink (for example, second ink, third ink, fourth ink or the like) in the near region. Such mixing of different inks near the boundary region is usually called “bleeding between colors”. Along this boundary region, an undesirable deterioration in the print quality occurs, which leads to lowering in print quality. Use of such an ink tends to cause bleeding of a fine line or dot in not only a multicolor image or document but also a single color image or document, which may cause a problem that characters or the like cannot be printed with desired accuracy. There is accordingly an eager demand for the development of a coloring agent exhibiting, in an image or document printed by an inkjet printer, a good fixing property to a receiver material and undergoing a small hue change under high humidity conditions.

The present inventors of the present application developed an azo dye composed of an aminopyrazole diazo component and a pyridine coupler and exhibiting fastness to an oxidizing gas such as ozone (JP-A-2002-371214). The dye however did not have a sufficient fixing property to a receiver material particularly under high humidity conditions and underwent a large change in hue. As a method of overcoming the above-described problem, that of introducing an associative group typified by a nitrogen-containing heterocycle such as triazilyl group or carboxyl group is known (JP-A-2004-149561). The ink fixing property under high humid conditions is still insufficient and this composition cannot satisfy all the qualities required for the image formed by inkjet recording without lowering their levels.

### SUMMARY OF THE INVENTION

The aim of the invention is to overcome the above-described problems of the prior art and to accomplish the below-described objects.

An object of the present invention is to provide:

(1) a novel dye which has an absorption characteristic excellent in color reproducibility as a dye of three primary colors and having sufficient fastness against light, heat, humidity and active gases in the environment;

(2) a coloring composition which can give a colored image or coloring material excellent in hue and fastness and thus can be suited to prepare a printing ink composition for ink jet recording, etc., an ink sheet in a thermal transfer type image forming material, a toner for electrophotography, a color filter for display such as LCD and PDP or imaging device such as CCD and a dyeing solution for dyeing various fibers;

(3) an inkjet recording ink composition having a good hue because of the use of the above-described dye and capable of forming an image having high fastness against light, active gases in the environment, especially an ozone gas; and

(4) an inkjet recording ink composition capable of forming a recorded image with less bleeding during image formation and during long-term storage.

The present inventors synthesized various dyes and investigated their performances in detail. As a result, it has been found that the aim of the invention can be accomplished by using a compound represented by the below-described formula (1).

The invention embraces below-described coloring compositions and inkjet recording method.

(1) A coloring composition comprising a dye compound represented by formula (I): 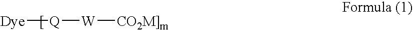
wherein Dye represents a dye structure portion;

Q represents —SO—, —SO₂—, —SO₂NR₁₁—, —CO— or —CONR₁₂— in which R₁₁ and R₁₂ each independently represents a hydrogen atom or a substituent;

W represents a divalent aliphatic group;

M represents an ionic group; and

m represents an integer of 1 or greater, and

wherein the dye compound satisfies conditions 1 and 2:

Condition 1: 200<Mw/(the number of CO₂M groups contained in the dye compound)<500

Condition 2: (the number of CO₂M groups contained in the dye compound)/p>0.5,

with the proviso that Mw represents a molecular weight of the dye compound represented by the formula (1); and

p represents the total number of ionic hydrophilic groups substituted on the dye compound represented by the formula (1).

(2) The coloring composition as described in (1) above,

wherein the dye compound satisfies equation:
(the number of CO₂M groups contained in the dye compound)/p≧0.75.

(3) The coloring composition as described in (1) or (2) above,

wherein M represents sodium or potassium.

(4) The coloring composition as described in any of (1) to (3) above,

wherein the dye structure portion represented by Dye is an azo dye represented by formula (2):
A-N═N—B Formula (2)
wherein A and B each independently represents a heterocycle which may be substituted; and

-Q-W—CO₂M in the formula (1) may be substituted in either one of A or B or both of A and B.

(5) The coloring composition as described in (4) above,

wherein the azo dye represented by the formula (2) is an azo dye represented by formula (3): 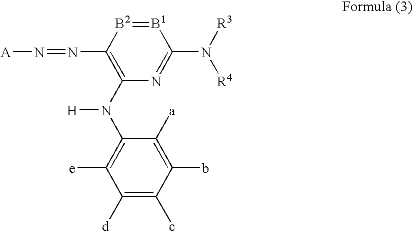
wherein A has the same meaning as described in the formula (2);

B¹ and B² each independently represents —CR¹═ or —CR²═, or either one represents a nitrogen atom and the other one represents —CR¹═ or —CR²═;

R³ and R⁴ each independently represents a hydrogen atom, aliphatic group, aromatic group, heterocyclic group, acyl group, alkoxycarbonyl group, aryloxycarbonyl group, carbamoyl group, alkylsulfonyl group, arylsulfonyl group or sulfamoyl group, which may be substituted further;

R¹ and R² each independently represents a hydrogen atom, halogen atom, aliphatic group, aromatic group, heterocyclic group, cyano group, carboxyl group, carbamoyl group, alkoxycarbonyl group, aryloxycarbonyl group, acyl group, hydroxy group, alkoxy group, aryloxy group, silyloxy group, acyloxy group, carbamoyloxy group, heterocyclic oxy group, alkoxycarbonyloxy group, aryloxycarbonyloxy group, alkylamino group, arylamino group, heterocyclic amino group, acylamino group, ureido group, sulfamoylamino group, alkoxycarbonylamino group, aryloxycarbonylamino group, alkyl- or arylsulfonylamino group, aryloxycarbonylamino group, nitro group, alkyl- or arylthio group, alkyl- or aryl-sulfonyl group, alkyl- or arylsulfinyl group, sulfamoyl group, sulfo group or heterocyclic thio group, which may be substituted further, or R¹ and R³ or R³ and R⁴ may be coupled to form a 5- or 6-membered ring;

a and e each independently represents an alkyl group, alkoxy group or halogen atom which may be substituted further; and

b, c and d each independently has the same meaning as R¹ and R², or a and b or e and d may be fused each other.

(6) An inkjet recording ink composition comprising a coloring composition as described in any of (1) to (5) above.

(7) An inkjet recording method, which comprises:

forming an image on a receiver material, which comprises a support; and an ink absorbing layer containing an inorganic white pigment on the support, by utilizing an inkjet recording ink composition as described in (6) above.

### DETAILED DESCRIPTION OF THE INVENTION

The present invention will next be described more specifically.

The coloring composition of the invention is characterized in that it contains a compound represented by the formula (1) having a carboxyl group bound to Dye, which is a dye portion, via a linking group.

In the invention, the dye portion represented by Dye in the formula (1) may have any structure. For example, it may have any structure belonging to dyes, which are classified by structure, as described in Masao Yokote and Fukumatsu Shibamiya, Gosei Senryo (published by Nikkan Kogyo Shimbun, 1978), P. F. Gordon and P. Gregory, Organic Chemistry in Colour (Springer-Verlag, 1987), or the like.

Preferred examples of the dye portion represented by Dye in the invention include azo dye, azomethine dye, methine dye, quinone dye, quinophthalone dye, nitro.nitroso dye, acridine dye, oxonol dye, merocyanine dye, triphenylmethane dye, xanthene dye, phthalocyanine dye, anthraquinone dye, indigo dye and thioindigo dye. Of these, azo dye is especially preferred.

Q represents —SO—, —SO₂—, —SO₂NR₁₁—, —CO— or —CONR₁₂— in which R₁₁ and R₁₂ each independently represents a hydrogen atom or a substituent. The following groups can be given as examples of the substituent.

Examples include halogen atoms, alkyl groups, alkenyl groups, alkynyl groups, aryl groups, heterocyclic groups, cyano group, hydroxyl group, nitro group, carboxyl group, alkoxy groups, aryloxy groups, silyloxy groups, heterocyclic oxy groups, acyloxy groups, carbamoyloxy groups, alkoxycarbonyloxy groups, aryloxycarbonyloxy groups, amino groups, acylamino groups, aminocarbonylamino groups, alkoxycarbonylamino groups, aryloxycarbonylamino groups, sulfamoylamino groups, alkyl- or arylsulfonylamino groups, mercapto group, alkylthio groups, arylthio groups, heterocyclic thio groups, sulfamoyl groups, sulfo group, alkyl- or arylsulfinyl groups, alkyl or arylsulfonyl groups, acyl groups, aryloxycarbonyl groups, alkoxycarbonyl groups, carbamoyl groups, aryl- or heterocyclic azo groups, imide groups, phosphino groups, phosphinyl groups, phosphinyloxy groups, phosphinylamino groups and silyl groups.

The term “aliphatic group” as used herein means an alkyl group, substituted alkyl group, alkenyl group, substituted alkenyl group, alkynyl group, or substituted alkynyl group. The term “aromatic group” as used herein means an aryl group or a substituted aryl group.

The halogen atoms are, more specifically, fluorine atom, chlorine atom, bromine atom and iodine atom.

The term “alkyl group” embraces linear, branched or cyclic alkyl groups which may be substituted or not, and it also embraces cycloalkyl groups, bicycloalkyl groups and tricyclo structure with may cyclic structures. This will equally apply to the alkyl group in the substituent (for example, alkyl group in the alkoxy or alkylthio group) which will be described below. More specifically, preferred examples of the alkyl group include C₁₋₃₀ alkyl groups such as methyl, ethyl, n-propyl, isopropyl, t-butyl, n-octyl, eicosyl, 2-chloroethyl, 2-cyanoethyl and 2-ethylhexyl. Preferred examples of the cycloalkyl group include substituted or unsubstituted C₃₋₃₀ cycloalkyl groups such as cyclohexyl, cyclopentyl and 4-n-dodecylcyclohexyl. Preferred examples of the bicycloalkyl group include substituted or unsubstituted C₅₋₃₀ bicycloalkyl groups, that is, monovalent groups obtained by removing a hydrogen atom from C₅₋₃₀ bicycloalkanes, such as bicyclo[1,2,2]heptan-2-yl and bicyclo[2,2,2]octan-3-yl.

The term “alkenyl group” embraces linear, branched or cyclic, substituted or unsubstituted alkenyl groups and it also embraces cycloalkenyl and bicycloalkenyl groups. Preferred specific examples of the alkenyl group include substituted or unsubstituted C₂₋₃₀ alkenyl groups such as vinyl, allyl, prenyl, geranyl and oleyl. Preferred examples of the cycloalkenyl group include substituted or unsubstituted C₃₋₃₀ cycloalkenyl groups, that is, monovalent groups obtained by removing a hydrogen atom from C₃₋₃₀ cycloalkenes, such as 2-cyclopenten-1-yl and 2-cyclohexen-1-yl. Examples of the bicycloalkenyl group include substituted or unsubstituted bicycloalkenyl groups, preferably substituted or unsubstituted C₅₋₃₀ bicycloalkenyl groups, that is, monovalent groups obtained by removing a hydrogen atom from bicycloalkenes having one double bond, such as bicyclo[2,2,1]hept-2-en-1-yl and bicyclo[2,2,2]oct-2-en-4-yl.

Preferred examples of the alkynyl group include substituted or unsubstituted C₂₋₃₀ alkynyl groups such as ethynyl, propargyl and trimethylsilylethynyl.

Preferred examples of the aryl group include substituted or unsubstituted C₆₋₃₀ aryl groups such as phenyl, p-tolyl, naphthyl, m-chlorophenyl and o-hexadecanoylaminophenyl.

Preferred examples of the heterocyclic group include monovalent groups obtained by removing a hydrogen atom from 5- or 6-membered, substituted or unsubstituted, aromatic or nonaromatic heterocyclic compounds, more preferably, 5- or 6-membered aromatic C₃₋₃₀ heterocyclic groups such as 2-furyl, 2-thienyl, 2-pyrimidinyl and 2-benzothiazolyl.

Preferred examples of the alkoxy group include substituted or unsubstituted C₁₋₃₀ alkoxy groups such as methoxy, ethoxy, isopropoxy, t-butoxy, n-octyloxy and 2-methoxyethoxy.

Preferred examples of the aryloxy group include substituted or unsubstituted C₆₋₃₀ aryloxy groups such as phenoxy, 2-methylphenoxy, 4-t-butylphenoxy, 3-nitrophenoxy and 2-tetradecanoylaminophenoxy.

Preferred examples of the silyloxy group include substituted or unsubstituted C₀₋₂₀ silyloxy groups such as trimethylsilyloxy and diphenylmethylsilyloxy.

Preferred examples of the heterocyclic oxy group include substituted or unsubstituted C₂₋₃₀ heterocyclic oxy groups such as 1-phenyltetrazol-5-oxy and 2-tetrahydropyranyloxy.

Preferred examples of the acyloxy group include formyloxy group, substituted or unsubstituted C₂₋₃₀ alkylcarbonyloxy groups and substituted or unsubstituted C₆₋₃₀ arylcarbonyloxy groups such as acetyloxy, pivaloyloxy, stearoyloxy, benzoyloxy and p-methoxyphenylcarbonyloxy.

Preferred examples of the carbamoyloxy group include substituted or unsubstituted C₁₋₃₀ carbamoyloxy groups such as N,N-dimethylcarbamoyloxy, N,N-diethylcarbamoyloxy, morpholinocarbonyloxy, N,N-di-n-octylaminocarbonyloxy and N-n-octylcarbamoyloxy.

Preferred examples of the alkoxycarbonyloxy group include substituted or unsubstituted C₂₋₃₀ alkoxycarbonyloxy groups such as methoxycarbonyloxy, ethoxycarbonyloxy, t-butoxycarbonyloxy and n-octylcarbonyloxy.

Preferred examples of the aryloxycarbonyloxy group include substituted or unsubstituted C₇₋₃₀ aryloxycarbonyloxy groups such as phenoxycarbonyloxy, p-methoxyphenoxycarbonyloxy and p-n-hexadecyloxyphenoxycarbonyloxy.

Examples of the amino group include alkylamino groups, arylamino groups and heterocyclic amino groups, preferably amino group, substituted or unsubstituted C₁₋₃₀ alkylamino groups, and substituted or unsubstituted C₆₋₃₀ anilino groups, such as methylamino, dimethylamino, anilino, N-methylanilino and diphenylamino.

Preferred examples of the acylamino group include formylamino group, substituted or unsubstituted C₁₋₃₀ alkylcarbonylamino groups and substituted or unsubstituted C₆₋₃₀ arylcarbonylamino groups such as acetylamino, pivaloylamino, lauroylamino, benzoylamino and 3,4,5-tri-n-octyloxyphenylcarbonylamino.

Preferred examples of the aminocarbonylamino group include substituted or unsubstituted C₁₋₃₀ aminocarbonylamino groups such as carbamoylamino, N,N-dimethylaminocarbonylamino, N,N-diethylaminocarbonylamino and morpholinocarbonylamino.

Preferred examples of the alkoxycarbonylamino group include substituted or unsubstituted C₂₋₃₀ alkoxycarbonylamino groups such as methoxycarbonylamino, ethoxycarbonylamino, t-butoxycarbonylamino, n-octadecyloxycarbonylamino and N-methylmethoxycarbonylamino.

Preferred examples of the aryloxycarbonylamino group include substituted or unsubstituted C₇₋₃₀ aryloxycarbonylamino groups such as phenoxycarbonylamino, p-chlorophenoxycarbonylamino and m-n-octyloxyphenoxycarbonylamino.

Preferred examples of the sulfamoylamino group include substituted or unsubstituted C₀₋₃₀ sulfamoylamino groups such as sulfamoylamino, N,N-dimethylaminosulfonylamino and N-n-octylaminosulfonylamino.

Preferred examples of the alkyl- or arylsulfonylamino group include substituted or unsubstituted C₁₋₃₀ alkylsulfonylamino groups and substituted or unsubstituted C₆₋₃₀ arylsulfonylamino groups such as methylsulfonylamino, butylsulfonylamino, phenylsulfonylamino, 2,3,5-trichlorophenylsulfonylamino and p-methylphenylsulfonylamino.

Preferred examples of the alkylthio group include substituted or unsubstituted C₁₋₃₀ alkylthio groups such as methylthio, ethylthio and n-hexadecylthio.

Preferred examples of the arylthio group include substituted or unsubstituted C₆₋₃₀ arylthio groups such as phenylthio, p-chlorophenylthio and m-methoxyphenylthio.

Preferred examples of the heterocyclic thio group include substituted or unsubstituted C₂₋₃₀ heterocyclic thio groups such as 2-benzothiazolylthio and 1-phenyltetrazol-5-ylthio.

Preferred examples of the sulfamoyl group include substituted or unsubstituted C₀₋₃₀ sulfamoyl groups such as N-ethylsulfamoyl, N-(3-dodecyloxypropyl)sulfamoyl, N,N-dimethylsulfamoyl, N-acetylsulfamoyl, N-benzoylsulfamoyl and N-(N′-phenylcarbamoyl)sulfamoyl.

Preferred examples of the alkyl- or arylsulfinyl group include substituted or unsubstituted C₁₋₃₀ alkylsulfinyl groups and substituted or unsubstituted C₆₋₃₀ arylsulfinyl groups such as methylsulfinyl, ethylsulfinyl, phenylsulfinyl and p-methylphenylsulfinyl.

Preferred examples of the alkyl- or arylsulfonyl group include substituted or unsubstituted C₁₋₃₀ alkylsulfonyl groups or substituted or unsubstituted C₆₋₃₀ arylsulfonyl groups such as methylsulfonyl, ethylsulfonyl, phenylsulfonyl and p-methylphenylsulfonyl.

Preferred examples of the acyl group include formyl group, substituted or unsubstituted C₂₋₃₀ alkylcarbonyl groups, substituted or unsubstituted C₇₋₃₀ arylcarbonyl groups and substituted or unsubstituted C₂₋₃₀ heterocyclic carbonyl groups which are bonded to a carbonyl via a carbon atom, such as acetyl, pivaloyl, 2-chloroacetyl, stearoyl, benzoyl, p-n-octyloxyphenylcarbonyl, 2-pyridylcarbonyl and 2-furylcarbonyl.

Preferred examples of the aryloxycarbonyl group include substituted or unsubstituted C₇₋₃₀ aryloxycarbonyl groups such as phenoxycarbonyl, o-chlorophenoxycarbonyl, m-nitrophenoxycarbonyl and p-t-butylphenoxycarbonyl.

Preferred examples of the alkoxycarbonyl group include substituted or unsubstituted C₂₋₃₀ alkoxycarbonyl groups such as methoxycarbonyl, ethoxycarbonyl, t-butoxycarbonyl and n-octadecyloxycarbonyl.

Preferred examples of the carbamoyl group include substituted or unsubstituted C₁₋₃₀ carbamoyl groups such as carbamoyl, N-methylcarbamoyl, N,N-dimethylcarbamoyl, N,N-di-n-octylcarbamoyl and N-(methylsulfonyl)carbamoyl.

Preferred examples of the aryl- or heterocyclic azo group include substituted or unsubstituted C₆₋₃₀ arylazo groups and substituted or unsubstituted C₃₋₃₀ heterocyclic azo groups, such as phenylazo, p-chlorophenylazo and 5-ethylthio-1,3,4-thiadiazol-2-ylazo.

Preferred examples of the imide group include N-succinimide and N-phthalimide.

Preferred examples of the phosphino group include substituted or unsubstituted C₀₋₃₀ phosphino groups such as dimethylphosphino, diphenylphosphino and methylphenoxyphosphino.

Preferred examples of the phosphinyl group include substituted or unsubstituted C₀₋₃₀ phosphinyl groups such as phosphinyl, dioctyloxyphosphinyl and diethoxyphosphinyl.

Preferred examples of the phosphinyloxy group include substituted or unsubstituted C₀₋₃₀ phosphinyloxy groups such as diphenoxyphosphinyloxy and dioctyloxyphosphinyloxy.

Preferred examples of the phosphinylamino group include substituted or unsubstituted C₀₋₃₀ phosphinylamino groups such as dimethoxyphosphinylamino and dimethylaminophosphinylamino.

Preferred examples of the silyl group include substituted or unsubstituted C₀₋₃₀ silyl groups such as trimethylsilyl, t-butyldimethylsilyl and phenyldimethylsilyl.

With respect to the above-described substituents having a hydrogen atom, the hydrogen atom may be replaced with the above-described substituent. Examples of such a substituent include alkylcarbonylaminosulfonyl groups, arylcarbonylaminosulfonyl groups, alkylsulfonylaminocarbonyl groups and arylsulfonylaminocarbonyl groups. Specific examples of them include methylsulfonylaminocarbonyl, p-methylphenylsulfonylaminocarbonyl, acetylaminosulfonyl and benzoylaminosulfonyl groups.

Q preferably represents —SO₂NR₁₁— or —CONR₁₂—, especially preferably —SO₂NR₁₁—. R₁₁ and R₁₂ each preferably represents a hydrogen atom, alkyl group, aryl group or heterocyclic group, especially preferably a hydrogen atom or alkyl group.

W represents a divalent aliphatic group, preferably a substituted or unsubstituted alkylene group, especially preferably an unsubstituted alkylene group, for example, —CH₂— or —(CH₂)₂—.

M represents a counter ion group. Examples include hydrogen atom, ammonium ion, alkali metal ions (such as lithium ion, sodium ion and potassium ion) and organic cations (such as tetramethylammonium ion, tetramethylguanidium ion and tetramethylphosphonium ion). As M, alkali metal ions are preferred, with sodium and potassium being especially preferred.

The letter m represents an integer of 1 or greater. It may be any integer insofar as it can satisfy the below-described condition 1, preferably from 1 to 10, especially preferably from 2 to 8. In the below-described condition, Mw represents the molecular weight of the dye compound.

In addition, the dye compound of the invention satisfies the below-described conditions 1 and 2.

Condition 1: 200<Mw/(the number of CO₂M groups contained in the dye compound)<500

Condition 2: (the number of CO₂M groups contained in the dye compound)/p>0.5, with the proviso that Mw represents the molecular weight of the dye compound represented by the formula (1) and p represents the total number of ionic hydrophilic groups substituted on the dye compound represented by the formula (1).

The term “ionic hydrophilic group” as used herein means a carboxyl group, sulfo group, phosphono group or quaternary ammonium group. The letter p represents any integer insofar as it is an integer of 1 or greater which satisfies the condition 2. It is preferably from 1 to 10, more preferably from 2 to 8. A value of (the number of CO₂M groups contained in the dye compound)/p is preferably 0.75 or greater, especially preferably 0.9 or greater.

In the invention, the dye portion structure represented by Dye is a heteryl-heteryl azo dye represented by the following formula (2).
A-N═N—B Formula (2)

In the formula (2), A and B each independently represents a heterocyclic group which may be substituted. The heterocyclic group is preferably that composed of a 5- or 6-membered ring and it may be either a monocyclic structure or a polycyclic structure in which at least two rings have been fused. The above-described heterocyclic group preferably contains at least any one of N, O and S atoms.

Examples of the heterocyclic group composed of 5- or 6-membered ring preferred as a heterocyclic group represented by A or B include thienyl, furyl, pyrrolyl, indolyl, imidazolyl, benzimidazolyl, pyrazolyl, indazolyl, thiazolyl, benzothiazolyl, isothiazolyl, benzisothiazolyl, oxazolyl, benzoxazolyl, isoxazolyl, 1,2,4-thiadiazolyl, 1,3,4-thiadiazolyl, 1,2,4-oxadiazolyl, 1,3,4-oxadiazolyl, triazolyl, pyridyl, pyrazyl, pyrimidyl, pyridazyl, quinolyl, isoquinolyl and phthalazinyl groups. They may have a substituent. Two substituents on the heterocyclic group may be coupled to form a fused ring. When the heterocyclic group contains a nitrogen atom, the nitrogen atom may have been quaternized.

The dye compound represented by the formula (2) has, in the molecule thereof, m pieces of Q-W—CO₂M. The positions of Q-W—CO₂Ms are not limited and they may be present in either A or B. The total number of them is however limited to m.

In the invention, the azo dye compound represented by the formula (2) is especially preferably an azo dye compound represented by the following formula (3):

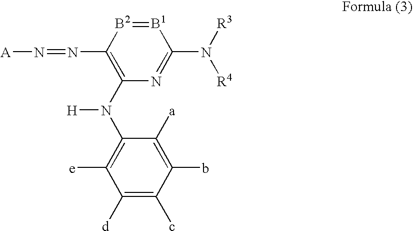

In the formula (3), A have the same meaning as A in the formula (2) and it represents a heterocyclic group. A is preferably a pyrazolyl, benzothiazolyl or isothiazolyl group, with pyrazolyl group being especially preferred.

B¹ and B² each represents —CR¹═ or —CR²═, or either one of the two represents a nitrogen atom and the other one represents —CR¹═ or —CR²═. R³ and R⁴ each independently represents a hydrogen atom, aliphatic group, aromatic group, heterocyclic group, acyl group, alkoxycarbonyl group, aryloxycarbonyl group, carbamoyl group, alkylsulfonyl group, arylsulfonyl group or sulfamoyl group. It may be substituted further.

R¹ and R² each independently represents a hydrogen atom, halogen atom, aliphatic group, aromatic group, heterocyclic group, cyano group, carboxyl group, carbamoyl group, alkoxycarbonyl group, aryloxycarbonyl group, acyl group, hydroxy group, alkoxy group, aryloxy group, silyloxy group, acyloxy group, carbamoyloxy group, heterocyclic oxy group, alkoxycarbonyloxy group, aryloxycarbonyloxy group, alkylamino group, arylamino group, heterocyclic amino group, acylamino group, ureido group, sulfamoylamino group, alkoxycarbonylamino group, aryloxycarbonylamino group, alkyl- or arylsulfonylamino group, aryloxycarbonylamino group, nitro group, alkyl- or arylthio group, alkyl- or aryl-sulfonyl group, alkyl- or arylsulfinyl group, sulfamoyl group, sulfo group or heterocyclic thio group. It may be substituted further. R¹ and R³ or R³ and R⁴ may be coupled to form a 5- or 6-membered ring.

The letters a and e each independently represents an alkyl group, alkoxy group or halogen atom and each of them may be substituted further; the letters b, c, and d each independently has the same meaning as R¹ and R², or a and b or e and d may be fused each other.

In the invention, the azo dye compounds represented by the formula (3) are most preferably compounds represented by the following formula (4).

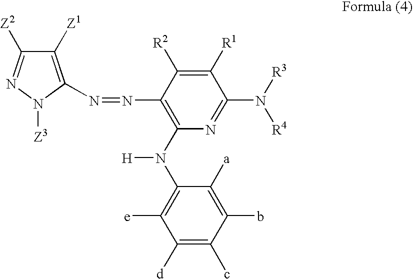

In the formula (4), Z¹ represents an electron attractive group having a Hammett's substituent constant σp of 0.20 or greater; Z² represents a hydrogen atom, acyl group, aliphatic group, aromatic group or heterocyclic group. Z³ represents a hydrogen atom, aliphatic group, aromatic group or heterocyclic group. The above-described group Z¹, Z² and Z³ each may have a substituent further. R¹, R², R³, R⁴, a, b, c, d and e have the same meanings as described above in the formula (3).

In the formula (4), Z¹ represents an electron attractive group having a Hammett's substituent constant σp of 0.20 or greater, preferably 0.30 or greater. The upper limit of the constant σp is preferably 1.0.

The Hammett's substituent constant σp used herein will next be described roughly. The Hammett's rule is an empirical rule which was proposed by L. P. Hammett in 1935 in order to quantitatively deal with the influence of substituents on the reaction or equilibrium of benzene derivatives and its reasonability has been widely admitted. The substituent constants determined in accordance with the Hammett's rule are σp value and σm value and they are described in many ordinary publications. For example, the details thereof are described in J. A. Dean, Lange's Handbook of Chemistry, 12^{th} Edition, 1979 (published by The McGraw-Hill Co.) and Kagaku no Ryoiki, Extra Edition, No. 122, pages 96 to 103, 1979 (published by Nankodo Co., Ltd.). The substituents are defined or explained by their Hammett's substituent constant σp values in this specification. This however does not mean that substituents are limited only to such substituents whose σp values are known in published literatures as described above. It is needless to say that they include all substituents having σp values falling within the defined range when measured on the basis of the Hammett's rule even though their σp values are not described in published literatures.

Specific examples of the electron attractive group having a σp value of 0.20 or greater include an acyl group, acyloxy group, carbamoyl group, alkyloxycarbonyl group, aryloxycarbonyl group, cyano group, nitro group, dialkylphosphono group, diarylphosphono group, diarylphosphinyl group, alkylsulfinyl group, arylsulfinyl group, alkylsulfonyl group, arylsulfonyl group, sulfonyloxy group, acylthio group, sulfamoyl group, thiocyanato group, thiocarbonyl group, halogenated alkyl group, halogenated alkoxy group, halogenated aryloxy group, halogenated alkylamino group, halogenated alkylthio group, heterocyclic group, halogen atom, azo group, selenocyanato group and aryl group substituted with another electron attractive group having a Hammett's substituent constant σp value of 0.20 or greater.

Z¹ preferably represents a cyano group, nitro group or halogen atom, of which halogen atom and cyano group are more preferred and cyano group is most preferred.

Z² represents a hydrogen atom, acyl group, aliphatic group, aromatic group or heterocyclic group. As Z², a hydrogen atom, alkyl group, cycloalkyl group, aralkyl group, aryl group, heterocyclic group and acyl group are preferred, with an alkyl group being more preferred. Each substituent may be substituted further.

Z³ preferably represents an aryl group substituted with an electron attractive group or a heterocyclic group, with a heterocyclic group being especially preferred and a benzothiazole group being most preferred.

Specific examples of the dye compounds of the invention represented by the formulas (1) to (4) will be described below, but the dye compounds to be used in the invention are not limited to the below-described examples.

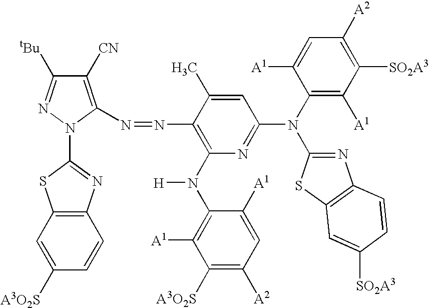

| | A¹ | A² | A³ |
|---|---|---|---|
| a-1 | C₂H₅ | CH₃ | —NHCH₂CO₂K |
| a-2 | CH₃ | CH₃ | —NHCH₂CO₂K |
| a-3 | C₂H₅ | H | —NH(CH₂)₂CO₂K |
| a-4 | C₂H₅ | CH₃ | —NH(CH₂)₂CO₂K |
| a-5 | CH₃ | CH₃ | —NH(CH₂)₂CO₂K |
| a-6 | ⁱPr | H | —NH(CH₂)₂CO₂K |
| a-7 | ⁱPr | CH₃ | —NH(CH₂)₂CO₂K |
| a-8 | C₂H₅ | CH₃ | —NH(CH₂)₂CO₂Na |
| a-9 | C₂H₅ | H | —NH(CH₂)₂CO₂Na |
| a-10 | C₂H₅ | CH₃ | —NH(CH₂)₂CO₂NH₄ |

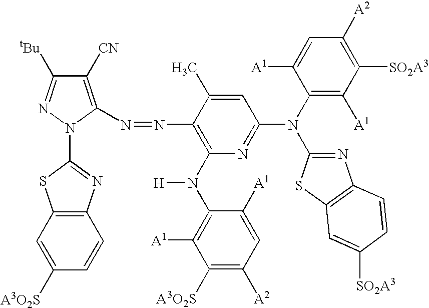

| | A¹ | A² | A³ |
|---|---|---|---|
| a-11 | C₂H₅ | CH₃ | —N(CH₃)CH₂CO₂Na |
| a-12 | CH₃ | CH₃ | —N(CH₃)CH₂CO₂K |
| a-13 | C₂H₅ | CH₃ | —NHCH(CH₃)CO₂K |
| a-14 | ⁱPr | CH₃ | —NH(CH₃)₈CO₂K |
| a-15 | C₂H₅ | CH₃ | —NHCH₂CH(OH)CO₂K |
| a-16 | Cl | H | —NHCH₂CH(OH)CO₂Na |
| a-17 | C₂H₅ | CH₃ | —NHCH(CH₂OH)CO₂K |
| a-18 | C₂H₅ | CH₃ | 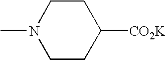 |
| a-19 | C₂H₅ | CH₃ | 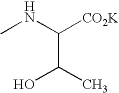 |
| a-20 | C₂H₅ | CH₃ | 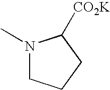 |

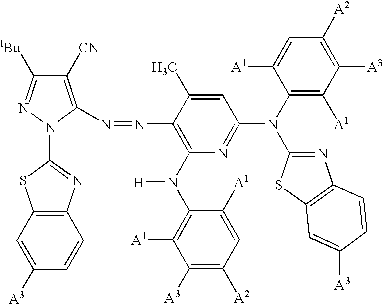

| | A¹ | A² | A³ |
|---|---|---|---|
| a-21 | C₂H₅ | CH₃ | —CONH(CH₂)₂CO₂K |
| a-22 | ⁱPr | CH₃ | —CON(CH₃)CH₂CO₂K |
| a-23 | C₂H₅ | CH₃ | —CON(CH₂CO₂Na)₂ |
| a-24 | C₂H₅ | H | —CON(CH₂CH₂CO₂K)₂ |
| a-25 | C₂H₅ | CH₃ | —SO₂(CH₂)₂CO₂K |
| a-26 | C₂H₅ | CH₃ | —SO₂CH₂CH(OH)CO₂K |
| a-27 | C₂H₅ | H | —SO(CH₂)₃CO₂NH₄ |
| a-28 | C₂H₅ | CH₃ | —CO(CH₂)₂CO₂K |
| a-29 | ⁱPr | H | —SO₂N(CH₂CO₂Na)₂ |
| a-30 | C₂H₅ | CH₃ | —SO₂N(CH₂CH₂CO₂Na)₂ |

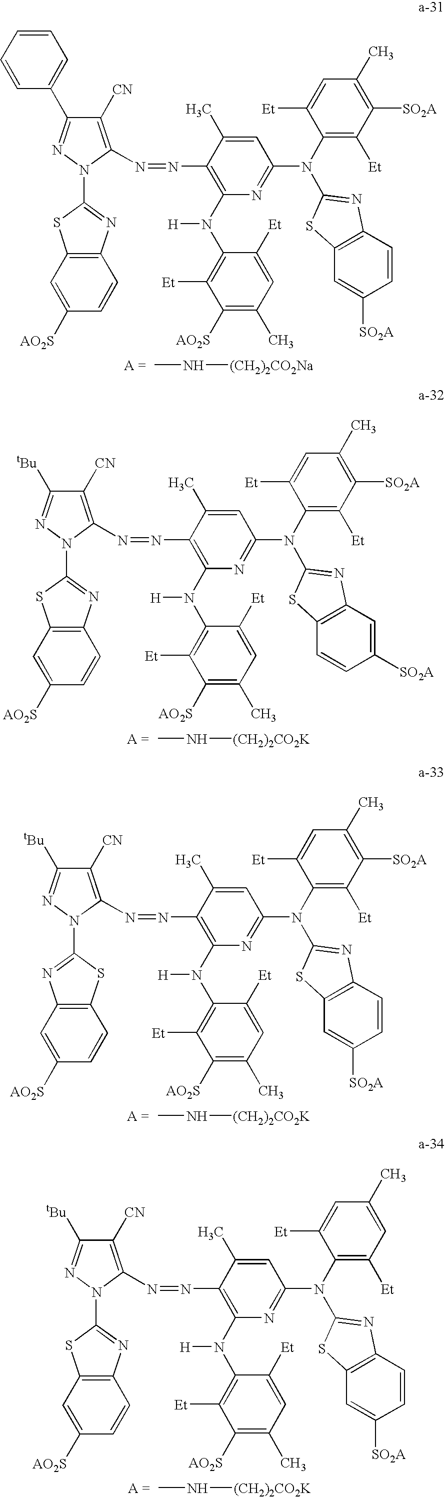

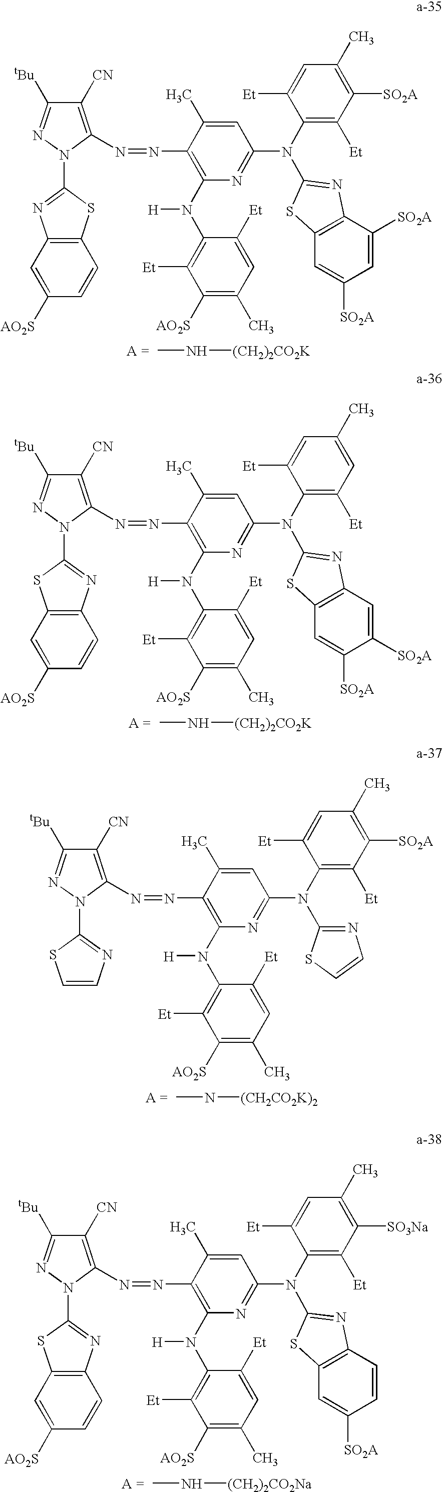

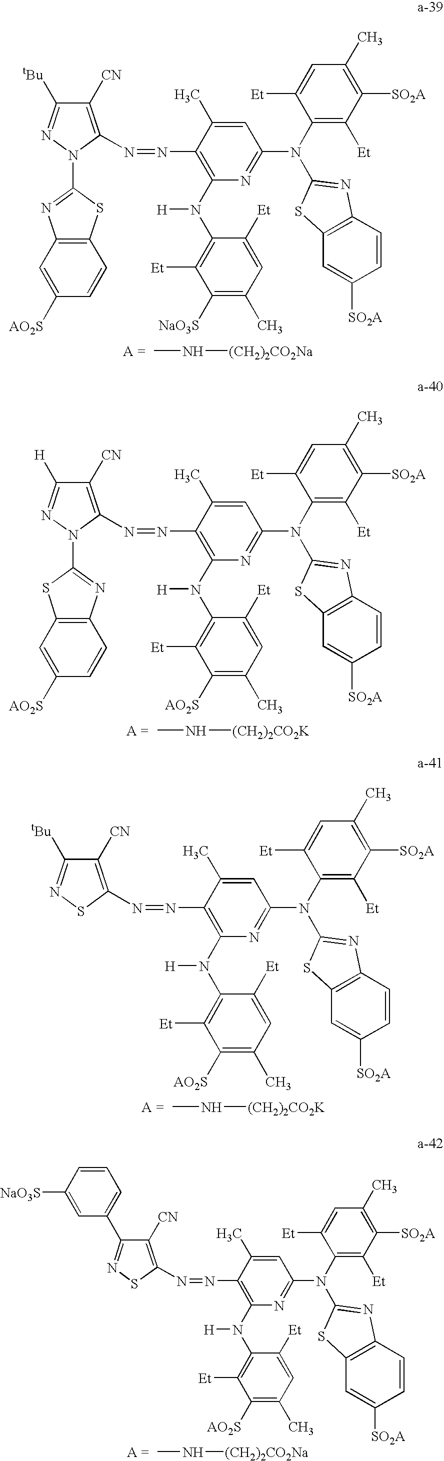

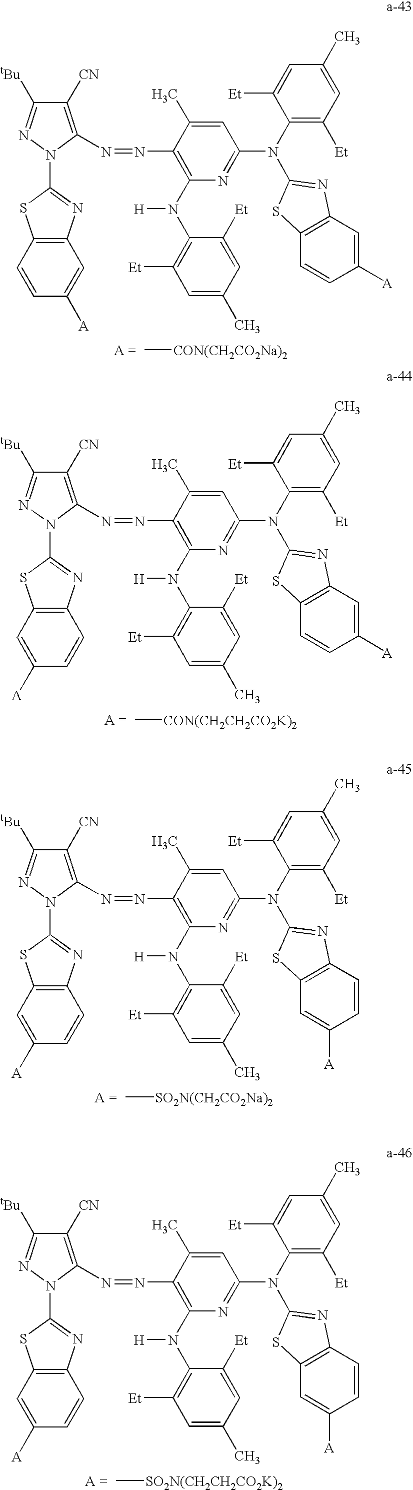

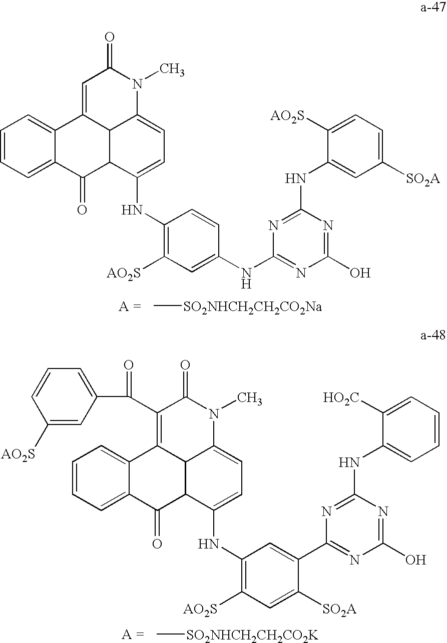

The azo group in the azo dye of the invention may be either an azo type or hydrazo type, depending on the structure of the compound, but any azo group is indicated herein as an azo type. Even if it has another tautomer, it is indicated herein as a typical type. A tautomer which is different from that described herein is also embraced by the compound of the invention.

In the invention, an isotope (such as 2H, 3H, 13C or 15N) may be contained in the compound represented by the formulas (1) to (4).

[Applications of the Coloring Composition]

The coloring composition of the invention can be used for an image recording material for forming an image, especially a color image. More specifically, it can be used for, as well as an inkjet system recording material which will be described in detail below, thermal transfer image recording material, pressure sensitive recording material, recording material using an electrophotographic system, transfer type silver halide photosensitive material, printing ink, recording pen and the like. Of these, inkjet system recording material, thermal transfer image recording material and recording material using an electrophotographic system are preferred applications, with inkjet system recording material being more preferred. It can also be used for color filters to be used in solid-state image pickup devices such as LCD and CCD which are described in U.S. Pat. No. 4,808,501 or JP-A-6-35182, and dyeing solutions for dyeing various fibers therewith.

Dyes of the invention can be used after their physical properties such as solubility and thermal transfer property are adjusted by a substituent to suit their applications. The dyes of the invention can be used, depending on the system, in the form of a uniform solution, in the form of a dispersed solution such as emulsion dispersion or even in the form of a solid dispersion.

[Inkjet Recording Ink Composition]

An inkjet recording ink composition (used synonymously with the term “inkjet recording ink”) can be prepared by dissolving and/or dispersing the dye compound of the invention in a lipophilic medium or water-based medium, preferably in a water-based medium. The composition may contain another additive if necessary without impairing the advantage of the invention. Examples of the another additive include known additives such as drying inhibitor (humectant), antifading agent, emulsion stabilizer, penetration accelerator, ultraviolet absorber, antiseptic, fungicide, pH regulator, surface tension regulating agent, defoaming agent, viscosity regulator, dispersant, dispersion stabilizer, rust inhibitive and chelating agent. These additives are each added to an ink solution directly in the case of a water soluble ink. When an oil soluble dye is used as a dispersion, it is the common practice to add the additive to the dye dispersion after preparation of the dispersion, but it may be added to an oil phase or aqueous phase when the dye dispersion is prepared.

The drying inhibitor is suitably used for the purpose of preventing drying of an inkjet ink, which will otherwise cause clogging therewith an ink orifice of a nozzle to be used for inkjet recording system.

The drying inhibitor is preferably a water-soluble organic solvent having a vapor pressure lower than that of water. Specific examples include polyols typified by ethylene glycol, propylene glycol, diethylene glycol, polyethylene glycol, thiodiglycol, dithiodiglycol, 2-methyl-1,3-propanediol, 1,2,6-hexanetriol, an acetylene glycol derivative, glycerol and trimethylolpropane; lower alkyl ethers of a polyol such as ethylene glycol monomethyl (or ethyl) ether, diethylene glycol monomethyl (or ethyl) ether and triethylene glycol monoethyl (or butyl) ether; heterocycles such as 2-pyrrolidone, N-methyl-2-pyrrolidone, 1,3-dimethyl-2-imodazolidinone and N-ethylmorpholine; sulfur-containing compounds such as sulfolane, dimethylsulfoxide and 3-sulfolene; polyfunctional compounds such as diacetone alcohol and diethanolamine; and urea derivatives. Of these compounds, polyols such as glycerin and diethylene glycol are preferred. These drying inhibitors may be used either singly or in combination. The drying inhibitor is preferably used in an amount of from 10 to 50 mass % in the ink composition. (In this specification, mass ratio is equal to weight ratio.)

Examples of the emulsion stabilizer include polyvinyl alcohol, anion-modified polyvinyl alcohol, cation-modified polyvinyl alcohol, gelatin, gum arabic, carboxymethyl cellulose, polyacrylamide, hydroxyethyl cellulose, methyl cellulose, ethyl cellulose, cellulose acetobutyrate, hydroxymethyl cellulose, polyvinylpyrrolidone, montmorillonite, ligninsulfonic acid, polystyrenesulfonic acid or copolymer thereof, hydrolysate of a maleic anhydride copolymer, polyacrylic acid or copolymer thereof, polymethacrylic acid or copolymer thereof, and polyacrylamidomethylpropanesulfonic acid or copolymer thereof, and salts thereof. These emulsion stabilizers may be used either singly or in combination.

The penetration accelerator is used suitably for the purpose of accelerating the penetration of an inkjet ink to paper. Examples of it include alcohols such as ethanol, isopropanol, butanol, di- or tri-ethylene glycol monobutyl ether and 1,2-hexanediol, sodium lauryl sulfate, sodium oleate, and nonionic surfactants. Addition of it in an amount of from 5 to 30 mass % in an ink usually brings about a sufficient effect and it is added preferably in an amount within a range causing neither bleeding of print nor print through.

The ultraviolet absorber is used for the purpose of improving the storage stability of an image. Examples include benzotriazole compounds as described, for example, in JP-A-58-185677, JP-A-61-190537, JP-A-2-782, JP-A-5-197075 and JP-A-9-34057, benzophenone compounds as described, for example, in JP-A-46-2784, JP-A-5-194483 and U.S. Pat. No. 3,214,463, cinnamic acid compounds as described, for example, in JP-B-48-30492, JP-B-56-21141 and JP-A-10-88106, triazine compounds as described, for example, in JP-A-4-298503, JP-A-8-53427, JP-A-8-239368, JP-A-10-182621 and International Patent Publication No. 8-501291, and compounds as described in Research Disclosure, No. 24239. So-called fluorescent whitening agents which are compounds typified by a stilbene or benzoxazole compound and absorbing ultraviolet light and emitting fluorescence can also be used.

The antifading agent is used for the purpose of improving the storage stability of an image. As the antifading agent, various organic antifading agents and metal complexes can be used. Examples of the organic antifading agent include hydroquinones, alkoxyphenols, dialkoxyphenols, phenols, anilines, amines, indanes, chromans, alkoxyanilines and heterocyclic compounds. Examples of the metal complexes include nickel complexes and zinc complexes. More specifically, compounds as described in patents cited in Research Disclosure, No. 17643, VII, Items I and J, ibid., No. 15162, ibid., No. 18716, page 650, left column, ibid., No. 36544, page 527, ibid., No. 307105, page 872 and ibid., No. 15162 and compounds included in the formulas and examples of representative compounds as described in JP-A-62-215272, pages 127 to 137.

Examples of the antiseptic include sodium benzoate, pentachlorophenol sodium, 2-pyridinethiol-1-oxide sodium, sodium sorbinate, sodium dehydroacetate, and 1,2-dibenzosothiazolin-3-one or salt thereof. It is added preferably in an amount of from 0.02 to 1.00 mass % in the ink.

Examples of the fungicide include sodium dehydroacetate, sodium benzoate, sodium pyridinethion-1-oxide, ethyl p-hydroxybenzoate, and 1,2-benzisothizolin-3-one or salt thereof. The fungicide is added preferably in an amount of from 0.02 to 1.00 mass % in the ink.

Examples of the rust inhibitive include acidic sulfites, sodium thiosulfate, ammonium thiodiglycolate, diisopropylammonium nitrite, pentaerythritol tetranitrate, and dicyclohexylammonium nitrite.

As the pH regulator, a neutralizing agent (organic base, inorganic alkali) can be used. The pH regulator is added preferably to control the inkjet ink to from pH 6 to 10, more preferably from pH 7 to 10 in order to improve the storage stability of the inkjet ink.

As the surface tension regulating agent, nonionic, cationic and anionic surfactants can be used. The surface tension of the inkjet ink is preferably from 20 to 60 mN/m, more preferably from 25 to 45 mN/m, while the viscosity of the inkjet ink is preferably 30 mPa·s or less. It is more preferred to adjust it to 20 mPa·s or less.

Preferred examples of the surfactant include anionic surfactants such as fatty acid salts, alkyl sulfates, alkylbenzene sulfonates, alkylnaphthalene sulfonates, dialkylsulfosuccinates, alkyl phosphates, naphthalenesulfonic acid-formalin condensate and polyoxyethylene alkyl sulfates, and nonionic surfactants such as polyoxyethylene alkyl ethers, polyoxyethylene alkyl aryl ethers, polyoxyethylene fatty acid esters, sorbitan fatty acid esters, polyoxyethylene sorbitan fatty acid esters, polyoxyethylene alkylamines, glycerin fatty acid esters and oxyethylene-oxypropylene block copolymer. “Surfynols” (trade name; product of Air Products & Chemicals, Inc.) which are acetylene based polyoxyethylene oxide surfactants are also preferred. Further, amine oxide amphoteric surfactants such as N,N-dimethyl-N-alkylamine oxide are also preferred. Moreover, surfactants as described in JP-A-59-157636, pages 37 to 38 and Research Disclosure, No. 308119 (1989) are also employed.

Examples of the viscosity regulator include proteins such as gelatin and casein, natural rubbers such as gum arabic, cellulose derivatives such as methyl cellulose, carboxymethyl cellulose and hydroxymethyl cellulose, natural polymers such as lignin sulfonates and shellac, polyacrylates, styrene-acrylic acid copolymer salts, polyvinyl alcohol and polyvinylpyrrolidone. Two or more of these viscosity regulators can be added.

As the dispersant or dispersion stabilizer, the above-described cationic, anionic and nonionic surfactants can be preferably employed.

As the defoaming agent, fluorine-containing compounds and silicone compounds can be used. As the chelating agent, EDTA can be given as an example.

When the dye compound of the invention is dispersed in an aqueous medium, it is preferred to disperse coloring fine particles containing a dye and an oil soluble polymer in an aqueous medium, as described in JP-A-11-286637, JP-A-2001-240763, JP-A-2001-262039 or JP-A-2001-247788; or dispersing the dye of the invention which has been dissolved in a high-boiling-point organic solvent in an aqueous medium, as described in JP-A-2001-262018, JP-A-2001-240763, or JP-A-2001-335734. The concrete method, kinds of the oil-soluble polymer, high-boiling-point organic solvent and additive, and their using amounts in the case where the dye of the invention is dispersed in an aqueous medium can be selected as needed with reference to those described in the above-described patent publications. The dye compound in the solid form may be directly dispersed into fine particles. At the time of dispersion, a dispersant or a surfactant may be used. Examples of the dispersing apparatus usable here include simple stirrers, impeller stirrers, in-line stirrers, mills (such as colloid mills, ball mills, sand mills, attritors, roll mills, agitator mills), ultrasonic stirrers, and high-pressure emulsifying dispersers (high-pressure homogenizers, such as commercially-available Gaulin homogenizer, microfluidizer and DeBEE2000). A preparation process of the above-described inkjet recording ink is described in detail also in JP-A-5-148436, JP-A-5-295312, JP-A-7-97541, JP-A-7-82515, JP-A-7-118584, JP-A-11-286637 and JP-A-2001-271003, in addition to the above-described patent publications, and they can be utilized for the preparation of the inkjet recording ink of the invention.

As the aqueous medium, a mixture composed mainly of water and optionally containing a water-miscible organic solvent can be used. Examples of the water-miscible organic solvent are alcohols (such as methanol, ethanol, propanol, isopropanol, butanol, isobutanol, sec-butanol, t-butanol, pentanol, hexanol, cyclohexanol and benzyl alcohol), polyols (such as ethylene glycol, diethylene glycol, triethylene glycol, polyethylene glycol, propylene glycol, dipropylene glycol, polypropylene glycol, butylene glycol, hexanediol, pentanediol, glycerin, hexanetriol and thiodiglycol), glycol derivatives (such as ethylene glycol monomethyl ether, ethylene glycol monoethyl ether, ethylene glycol monobutyl ether, diethylene glycol monomethyl ether, diethylene glycol monobutyl ether, propylene glycol monomethyl ether, propylene glycol monobutyl ether, dipropylene glycol monomethyl ether, triethylene glycol monomethyl ether, ethylene glycol diacetate, ethylene glycol monomethyl ether acetate, triethylene glycol monomethyl ether, triethylene glycol monoethyl ether and ethylene glycol monophenyl ether), amines (such as ethanolamine, diethanolamine, triethanolamine, N-methyldiethanolamine, N-ethyldiethanolamine, morpholine, N-ethylmorpholine, ethylenediamine, diethylenetriamine, triethylenetetramine, polyethyleneimine and tetramethylpropylenediamine), and other polar solvents (such as formamide, N,N-dimethylformamide, N,N-dimethylacetamide, dimethylsulfoxide, sulfolane, 2-pyrrolidone, N-methyl-2-pyrrolidone, N-vinyl-2-pyrrolidone, 2-oxazolidone, 1,3-dimethyl-2-imidazolidinone, acetonitrile and acetone). Two or more of the above-described water-miscible organic solvents may be used in combination.

The dye compound of the invention is added preferably in an amount of from 0.2 to 10 parts by mass to 100 parts by mass of the inkjet recording ink composition. The inkjet recording ink composition of the invention may contain another coloring agent together with the dye compound of the invention. When two or more coloring agents are added, the total content of all the coloring agents preferably falls within the above-described range.

The inkjet recording ink composition of the invention can be used not only for the formation of a single color image but also for the formation of a full color image. For the formation of a full color image, magenta color ink, cyan color ink and yellow color ink can be used. A black color ink can also be added in order to adjust the color tone.

As the yellow dye, any yellow dye is usable in the invention. Examples include arylazo or heterylazo dyes containing, as a coupling component (which will hereinafter be called “coupler component”), a phenol, naphthol, aniline, pyrazolone or pyridone or an open-chain active methylene compound; azomethine dyes containing, as a coupler component, an open-chain active methylene compound; methine dyes such as benzylidene dyes and monomethine oxonol dyes; quinone dyes such as naphthoquinone dyes and anthraquinone dyes; and the other dyes such as quinophthalone dyes, nitro and nitroso dyes, acridine dyes, and acridinone dyes.

As the cyan dyes, any cyan dyes are usable in the invention. Examples include arylazo or heterylazo dyes having as a coupler component a phenol, naphthol or aniline; azomethine dyes having as a coupler component a heterocycle such as phenol, naphthol or pyrrolotriazole; polymethine dyes such as cyanine dyes, oxonol dyes and merocyanine dyes; carbonium dyes such as diphenylmethane dyes, triphenylmethane dyes and xanthene dyes; phthalocyanine dyes; anthraquinone dyes; and indigo and thioindigo dyes.

These dyes may develop yellow or cyan color upon dissociation of a portion of the chromophore thereof. In such a case, a counter cation may be an inorganic cation such as an alkali metal or ammonium, an organic cation such as pyridinium or quaternary ammonium salt, or a polymer cation containing such a cation as a partial structure.

As the black dye, disazo, trisazo and tetrazo dyes and moreover, dispersed carbon black can be used in the invention.

[Inkjet Recording Method]

In the inkjet recording method of the invention, energy is given to the inkjet recording ink to form an image on a known image receiver material, for example, a plain paper, a resin-coated paper, a paper exclusively used for inkjet recording as described, for example, in JP-A-8-169172, JP-A-8-27693, JP-A-2-276670, JP-A-7-276789, JP-A-9-323475, JP-A-62-238783, JP-A-10-153989, JP-A-10-217473, JP-A-10-235995, JP-A-10-337947, JP-A-10-217597 and JP-A-10-337947, a film, paper for common use in electrophotography, cloth, glass, metal or ceramics.

When an image is formed, a polymer latex compound may be used in combination for the purpose of imparting luster or water resistance or improving weather resistance. The latex compound may be added to the receiver material either before or after the addition of the coloring agent, or even simultaneously. Therefore, the latex compound may be added to receiver paper or an ink or may be used independently as a liquid substance. Specifically, methods described in JP-A-2002-166638, JP-A-2002-121440, JP-A-2002-154201, JP-A-2002-144696, JP-A-2002-080759, JP-A-2002-187342 and JP-A-2002-172774 can preferably be employed.

The recording paper or recording film to be used for inkjet printing by using the ink composition of the invention will hereinafter be described in detail. A support for the recording paper or recording film usable in the invention is prepared, by various apparatuses such as Fourdrinier paper machine and cylinder paper machine, by using a chemical pulp such as LBKP or NBKP, a mechanical pulp such as GP, PGW, RMP, TMP, CTMP, CMP or CGP, or a waste paper pulp such as DIP, and mixing it, if necessary, with a conventionally known additive such as pigment, binder, sizing agent, fixing agent, cationic agent or paper strengthening agent. In addition to such a support, synthetic paper and plastic film sheet may also be used as the support. The thickness of the support is preferably from 10 to 250 μm and the basis weight is preferably from 10 to 250 g/m². An ink absorbing layer and a back coat layer may be provided directly on the support or these layers may be provided on the support after size-press with starch or polyvinyl alcohol or after disposal of an anchor-coat layer. The support may be planarized using a calendaring machine, for example, machine calendar, TG calendar or soft calendar. As the support, paper laminated on both sides thereof with polyolefin (such as polyethylene or polypropylene), polystyrene, polyethylene terephthalate or polybutene or a copolymer thereof and a plastic film are preferably used in the present invention. It is preferred to add a white pigment (such as titanium oxide or zinc oxide) or a tinting dye (such as cobalt blue, ultramarine or neodymium oxide) to the polyolefin.

The ink absorbing layer provided on the support contains a pigment and an aqueous binder. The pigment is preferably a white pigment. Examples of the white pigment include inorganic white pigments such as calcium carbonate, kaolin, talc, clay, diatomaceous earth, synthetic amorphous silica, aluminum silicate, magnesium silicate, calcium silicate, aluminum hydroxide, alumina, lithopone, zeolite, barium sulfate, calcium sulfate, titanium dioxide, zinc sulfide or zinc carbonate, and organic pigments such as styrene pigment, acrylic pigment, urea resin and melamine resin. As the white pigment contained in the ink absorbing layer, a porous inorganic pigment is preferred and synthetic amorphous silica having a large pore area is particularly suited. As the synthetic amorphous silica, both silicic anhydride available by a dry process and hydrous silicic acid available by a wet process can be used. Use of hydrous silicic acid is especially preferred.

Examples of the aqueous binder contained in the ink absorbing layer include water soluble polymers such as polyvinyl alcohol, silanol-modified polyvinyl alcohol, starch, cationic starch, casein, gelatin, carboxymethyl cellulose, hydroxyethyl cellulose, polyvinylpyrrolidone, polyalkylene oxide and polyalkylene oxide derivatives and water dispersible polymers such as styrene-butadiene latex and acrylic emulsion. These aqueous binders may be used either singly or in combination. In the invention, polyvinyl alcohol and silanol-modified polyvinyl alcohol are especially preferred from the viewpoints of adhesion to a pigment and peel resistance of the ink absorbing layer.

The ink absorbing layer may contain, in addition to the pigment and aqueous binder, a mordant, water-resistance imparting agent, light-fastness improving agent, surfactant or the like additive.

The mordant to be added to the ink absorbing layer is preferably immobilized. For such a purpose, a polymer mordant is preferably used.

The description of a polymer mordant can be found in JP-A-48-28325, JP-A-54-74430, JP-A-54-124726, JP-A-55-22766, JP-A-55-142339, JP-A-60-23850, JP-A-60-23851, JP-A-60-23852, JP-A-60-23853, JP-A-60-57836, JP-A-60-60643, JP-A-60-118834, JP-A-60-122940, JP-A-60-122941, JP-A-60-122942, JP-A-60-235134, JP-A-1-161236, U.S. Pat. No. 2,484,430, U.S. Pat. No. 2,548,564, U.S. Pat. No. 3,148,061, U.S. Pat. No. 3,309,690, U.S. Pat. No. 4,115,124, U.S. Pat. No. 4,124,386, U.S. Pat. No. 4,193,800, U.S. Pat. No. 4,273,853, U.S. Pat. No. 4,282,305 and U.S. Pat. No. 4,450,224. An image receiving material containing a polymer mordant as described in JP-A-1-161236, pages 212 to 215 is especially preferred. By using the polymer mordant as described in JP-A-1-161236, a color image having excellent image quality are obtained and in addition, the color image has improved light fastness.

The water-resistance imparting agent is effective to make the image resistant to water. As the water-resistance imparting agent, a cationic resin is especially preferred. Examples of such a cationic resin include polyamide polyamine epichlorohydrin, polyethyleneimine, polyaminesulfone, dimethyl diallyl ammonium chloride polymer, cationic polyacrylamide and colloidal silica. Of the cationic resins, polyamide polyamine epichlorohydrin is especially preferred. The content of the cationic resin is preferably from 1 to 15 mass %, especially preferably from 3 to 10 mass %, each based on the whole solid content of the ink absorbing layer.

Examples of the light-fastness improving agent include zinc sulfate, zinc oxide, hindered amine antioxidants and benzophenone or benzotriazole ultraviolet absorbers. Of these, zinc sulfate is especially preferred.

The surfactant functions as a coating aid, peeling improving agent, slipping improving agent or antistatic agent. The description of the surfactant can be found in JP-A-62-173463 and JP-A-62-183457. The surfactant may be replaced by an organofluoro compound. The organofluoro compound is preferably hydrophobic. Examples of the organofluoro compound include fluorine surfactants, oily fluorine compounds (such as fluorine oil) and solid fluorine compound resins (such as tetrafluoroethylene resin). The description of the organofluoro compound can be found in JP-B-57-9053 (columns 8 to 17), JP-A-61-20994 and JP-A-62-135826. Other additives to be added to the ink absorbing layer include pigment dispersant, thickener, defoaming agent, dye, fluorescent whitening agent, antiseptic, pH regulator, matting agent and hardener. The ink absorbing layer may be composed of one layer or two layers.

The recording paper or recording film may have a back coat layer. Examples of a component to be added to the back coat layer include a white pigment, an aqueous binder and other components. Examples of the white pigment to be contained in the back coat layer include inorganic white pigments such as light calcium carbonate, heavy calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudo boehmite, aluminum hydroxide, alumina, lithopone, zeolite, hydrated halloysite, magnesium carbonate and magnesium hydroxide, and organic pigments such as styrene plastic pigment, acrylic plastic pigment, polyethylene, microcapsule, urea resin and melamine resin.

Examples of the aqueous binder to be contained in the back coat layer include water soluble polymers such as styrene/maleate copolymer, a styrene/acrylate copolymer, polyvinyl alcohol, silanol-modified polyvinyl alcohol, starch, cationic starch, casein, gelatin, carboxymethyl cellulose, hydroxyethyl cellulose and polyvinylpyrrolidone, and water dispersible polymers such as styrene-butadiene latex and acrylic emulsion. Other components incorporated in the back coat layer include a defoaming agent, foam controller, dye, fluorescent whitening agent, antiseptic and water-resistance imparting agent.

To the constituent layer (including the back coat layer) of the ink jet recording paper or film may be added a polymer latex. The polymer latex is used in order to improve film properties, for example, stabilize the size, prevent curling, prevent adhesion and prevent cracks of the film. The description of the latex can be found in JP-A-62-245258, JP-A-62-136648 and JP-A-62-110066. When latex having a low glass transition point (40° C. or less) is added to a mordant-containing layer, cracks and curl of the layer can be prevented. Addition of polymer latex having a high glass transition point to the back coat layer can also prevents the layer from curling.

No limitation is imposed on the ink jet recording system employed for the ink composition of the invention and it can be used in known systems such as a charge control system wherein ink is ejected by an electrostatic attractive force, a drop on-demand system (pressure pulse system) utilizing an oscillating pressure of a piezoelectric element, an acoustic inkjet system in which an electric signal is converted into a sound beam and ink exposed to the sound beam is ejected by radiation pressure, and a thermal inkjet system in which ink is heated to form bubbles therein and is ejected utilizing the pressure thus generated. The ink jet recording system includes a system wherein small volumes of low-concentrated ink called photoink are ejected frequently, a system for improving image quality by using plural kinds of inks which are substantially equal in hue but different in concentration, and a system using colorless and transparent ink.

### EXAMPLES

The invention will hereinafter be described based on Examples. It should however be borne in mind that the invention is not limited to or by them.

### Example 1

<Synthesis Process of Dye Compound (a-8)>

(1) Synthesis Process of Intermediates (d-1) and (d-2)

They were synthesized in accordance with the process as described in JP-A-2002-371214.

(2) Synthesis Process of Intermediate (d-3)

To a suspension obtained by adding 1700 mL of acetonitrile and 3.5 mL of dimethylformamide to 83.7 g (70 mmol) of Intermediate (d-2) was added 62 mL (840 mmol) of thionyl chloride at room temperature. After the reaction mixture was heated under reflux for 3 hours, 850 mL of acetonitrile was distilled off by concentration under reduced pressure. The residue was poured into 2500 g of ice water and crystals thus precipitated were collected by filtration. They were washed with water and then dried, whereby 79.5 g (63.5 mmol, yield: 91%) of Intermediate (d-3) was obtained.

(3) Synthesis Process of Intermediate (d-4)

After 100 mL of dimethylacetamide was added to 12.3 g (80 mmol) of β-alanine ethyl ester hydrochloride to dissolve the latter in the former under heating, the resulting solution was cooled by water. Addition of 16.2 g (160 mmol) of triethylamine to the resulting solution caused precipitation of triethylamine hydrochloride and the reaction mixture became turbid. The reaction mixture was cooled further and 12.5 g (10 mmol) of Intermediate (d-3) was added in portions thereto, followed by stirring at 10° C. or less for 1 hour. To the reaction mixture was added 300 mL of 0.4N aqueous hydrochloric acid. The resulting mixture was extracted with ethyl acetate to separate it into layers. The organic layer was washed with water and saturated saline and dried over sodium sulfate. The filtrate obtained by filtration was concentrated. The resulting concentrate was purified by silica gel, whereby 12.7 g (8.1 mmol, yield: 81%) of Intermediate (d-4) was obtained.

(4) Synthesis Process of Dye Compound (a-8)

After 150 mL of ethanol was added to 12.3 g (8.05 mmol) of Intermediate (d-4) to dissolve the latter in the former under heating, the resulting solution was filtered to remove insoluble matters therefrom. To the filtrate was added dropwise 6.5 mL (32.6 mmol) of a 5N aqueous solution of sodium hydroxide. After stirring at room temperature for 1 hour, crystals thus precipitated were collected by filtration. The resulting crystals were washed with ethanol, whereby 10.5 g (6.8 mmol, yield: 84%) of Dye compound (a-8) was obtained. The synthesis route will next be shown.

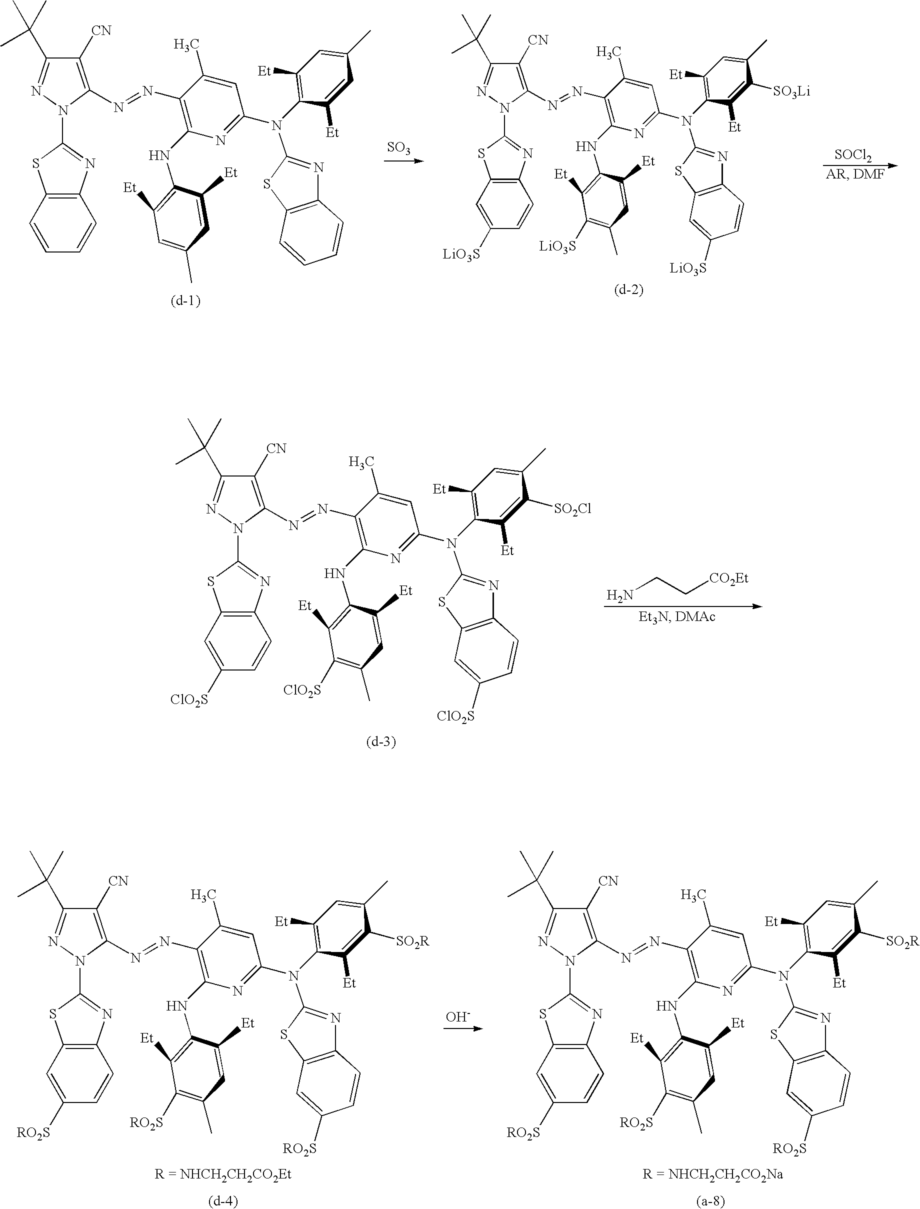

The below-described compounds were synthesized in a similar synthesis process. In Table 1, the maximum absorption wavelength λmax (nm) of each dye in water, Mw/(the number of CO₂M groups contained in the dye compound), (the number of CO₂M groups contained in the dye compound)/p are shown.

TABLE 1

| | | Mw/the number of | The number of |
|---|---|---|---|
| Compound No. | λmax (water) | COOM groups | COOM groups/p |
| a-1 | 552.4 nm | 390 | 1 |
| a-4 | 551.6 nm | 404 | 1 |
| a-8 | 551.6 nm | 400 | 1 |
| a-11 | 551.3 nm | 404 | 1 |
| a-18 | 549.9 nm | 445 | 1 |

### Example 2

(Preparation of Aqueous Ink)

After the below-described components were stirred for 1 hour while heating at from 30 to 40° C., the reaction mixture was filtered under pressure through a micro filter having an average pore size of 0.2 μm and a diameter of 47 mm to prepare Ink solution A.

—Composition of Ink Solution A—

| | | |
|---|---|---|
| Dye compound (a-1) | 3.5 | parts by mass |
| Diethylene glycol | 2 | parts by mass |
| Tetraethylene glycol monobutyl ether | 10 | parts by mass |
| Glycerin | 10 | parts by mass |
| 1,2-Hexanediol | 1 | part by mass |
| 2-Pyrrolidone | 1 | part by mass |
| Urea | 2 | parts by mass |
| Water | 70.5 | parts by mass |

In a similar manner to that employed for the preparation of Ink solution A except that the dye compound was changed as described below in Table 2, Ink solutions B to F were prepared.

(Image Recording and Evaluation)

An image was recorded on “Kassai Shashin Shiage Advance” (inkjet paper; product of Fuji Photo Film) by each of Ink solutions A to F and Inkjet printer (“PM-A700”, trade name; product of Seiko Epson).

The image thus formed was evaluated for its light fastness, ozone resistance and hue change under high humidity conditions.

The image density Ci immediately after recording was measured and then, after exposure to a xenon light (85,000 lux) for 7 days by using a weatherometer (“Atlas C. 165”), the image density Cf was again measured. The dye residual ratio ({(Ci−Cf)/Ci}×100%) was determined from a difference in image density between before and after exposure to the xenon light and light fastness was evaluated based on it. The image density was measured using a reflection densitometer (“X-Rite310TR”).

The dye residual ratio was measured at three points having reflection densities of 1, 1.5 and 2. The evaluation results are shown below in Table 2.

In Table 2, the sample was rated A when the dye residual ratio was 80% or greater at any density, rated B when the residual ratio was less than 80% at two points, and rated C when the residual ratio was less than 80% at all points.

In the evaluation of ozone resistance, an image just after recording was left alone for 24 hours in a box having an ozone gas concentration set at 5 ppm. The image densities before and after the image was left alone in the ozone gas atmosphere were measured by a reflection densitometer (“X-Rite 310TR”) and evaluated as the dye residual ratio. The ozone gas concentration in the box was set using an ozone gas monitor (Model “OZG-EM-01”) manufactured by APPLICS. The residual ratio was measured at three points having reflection densities of 1, 1.5 and 2.0, respectively. The sample was rated A when the dye residual ratio was 70% or greater at any density, rated B when the residual ratio less than 70% at two points, and rated C when the residual ratio was less than 70% at all points.

With regard to a hue change under high humidity conditions, the recorded image was left alone for 3 days under the conditions of 40° C. and 85% RH and a hue change between before and after it was left alone under high humid conditions was measured as Δa* value of Gray portion. The sample was rated A when Δa* was less than 2.0, rated B when Δa* was 2.0 or greater but less than 4.0, and rated C when Δa* is 4.0 or greater.

TABLE 2

| | | | Ozone | Hue change |
|---|---|---|---|---|
| Ink solution | Dye | Light fastness | resistance | (under high humidity condition) |
| A | a-1 | A | A | A |
| B | 1-8 | A | A | A |
| C | a-47 | B | B | A |
| D | Comparative dye 1 | A | A | C |
| E | Comparative dye 2 | C | C | B |
| F | Comparative dye 3 | C | C | C |

[Chemical formula 14]
Comparative dye 1 (Compound as described in JP-A-2004-149561)

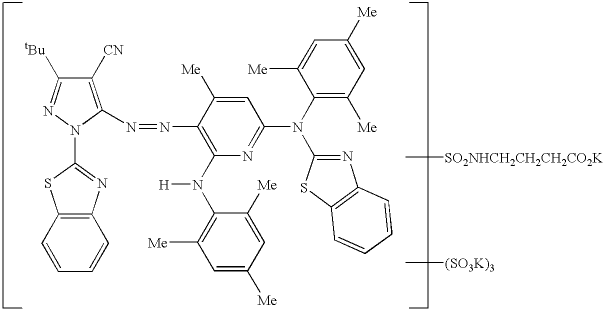

Mw/the number of COOM groups: 1359; the number of COOM groups/p: 0.25
Comparative Dye 2

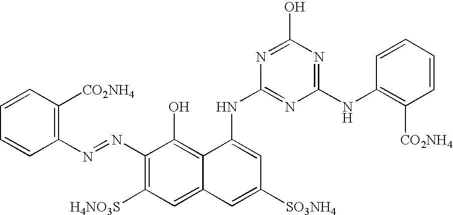

Comparative Dye 3

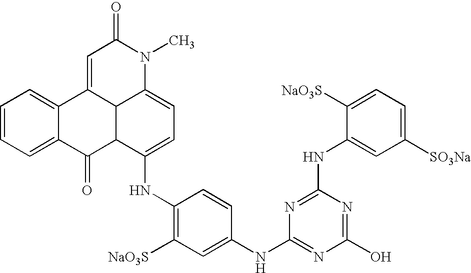

As is apparent from Table 2, compared with the image formed by Ink solution A or B containing the dye compound of the present invention, the image formed by Comparative ink solution D containing the dye which has a similar structure to the above-described one but does not satisfy the requirements of the dye compound of the invention is remarkably inferior in the hue change under high humidity conditions. The image formed by Ink solution E which is a typical magenta dye but does not satisfy the requirements of the dye compound of the invention is remarkably inferior in light fastness and ozone resistance. Moreover, compared with the image formed using Ink solution C containing the dye compound of the invention, the image formed by Comparative ink solution F which is similar in structure but does not satisfy the requirements of the dye compound of the invention is inferior in all of light fastness, ozone resistance and hue change under high humidity conditions. This suggests that the ink solution containing the dye compound of the invention provides an image excellent in light fastness, ozone resistance and hue change under high humidity conditions.

An image was recorded on photo paper “Kotaku” (“KA450PSK”, product of Seiko Epson) by using Ink solutions A to F and an inkjet printer (“PM-A700”, product of Seiko Epson). The resulting image was evaluated for light fastness, ozone resistance gas and hue change under high humidity conditions. Evaluation results are similar to those in Table 2.

### Example 3

Each ink prepared in Example 2 was filled in a cartridge of Inkjet printer “BJ-F850” (trade name; product of CANON) and an image was printed on “Super Photo Paper SP-101” (trade name; product of CANON) by the printer. The image was evaluated in a similar manner to that in Example 2, whereby similar results to Example 2 were obtained.

From the coloring composition of the invention, a colored image and a coloring material, especially an inkjet recording ink, excellent in hue and fastness against light and active gases, especially an ozone gas, in the environment can be obtained.

The coloring composition of the invention can be used as a coloring composition for an ink sheet in a thermal transfer image forming material, electrophotographic toner, color filter for displays such as LCD and PDP or imaging device such as CCD, or various coloring compositions such as dyeing solutions for dyeing various fibers.

The novel dye compound of the invention to be used for the coloring composition of the invention exhibits an absorption characteristic excellent in color reproducibility as a dye of three primary colors and at the same time has sufficient fastness against light, heat, humidity and active gases in the environment.

When the coloring composition of the invention is used as an inkjet recording ink, an image recorded using it undergoes a small change in hue during image formation and long-term storage.

The entire disclosure of each and every foreign patent application from which the benefit of foreign priority has been claimed in the present application is incorporated herein by reference, as if fully set forth.

What is claimed is:

1. A coloring composition comprising a dye compound represented by formula (I): 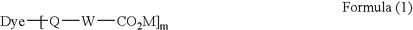
wherein Dye represents a dye structure portion;
Q represents —SO—, —SO₂—, —SO₂NR₁₁—, —CO— or —CONR₁₂— in which R₁₁ and R₁₂ each independently represents a hydrogen atom or a substituent;
W represents a divalent aliphatic group;
M represents an ionic group; and
m represents an integer of 1 or greater, and
wherein the dye compound satisfies conditions 1 and 2:
Condition 1: 200<Mw/(the number of CO₂M groups contained in the dye compound)<500
Condition 2: (the number of CO₂M groups contained in the dye compound)/p>0.5,
with the proviso that Mw represents a molecular weight of the dye compound represented by the formula (1); and
p represents the total number of ionic hydrophilic groups substituted on the dye compound represented by the formula (1).

2. The coloring composition according to claim 1,
wherein the dye compound satisfies equation:
(the number of CO₂M groups contained in the dye compound)/p≧0.75.

3. The coloring composition according to claim 1,
wherein M represents sodium or potassium.

4. The coloring composition according to claim 1,
wherein the dye structure portion represented by Dye is an azo dye represented by formula (2):
A-N═N—B Formula (2)
wherein A and B each independently represents a heterocycle which may be substituted; and
-Q-W—CO₂M in the formula (1) may be substituted in either one of A or B or both of A and B.

5. The coloring composition according to claim 4,
wherein the azo dye represented by the formula (2) is an azo dye represented by formula (3): 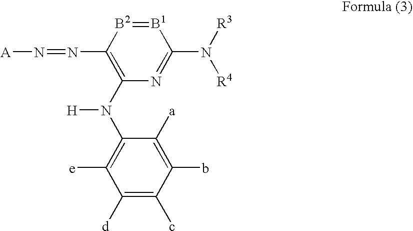
wherein A has the same meaning as described in the formula (2);
B¹ and B² each independently represents —CR¹═ or —CR²═, or either one represents a nitrogen atom and the other one represents —CR¹═ or —CR²═;
R³ and R⁴ each independently represents a hydrogen atom, aliphatic group, aromatic group, heterocyclic group, acyl group, alkoxycarbonyl group, aryloxycarbonyl group, carbamoyl group, alkylsulfonyl group, arylsulfonyl group or sulfamoyl group, which may be substituted further;
R¹ and R² each independently represents a hydrogen atom, halogen atom, aliphatic group, aromatic group, heterocyclic group, cyano group, carboxyl group, carbamoyl group, alkoxycarbonyl group, aryloxycarbonyl group, acyl group, hydroxy group, alkoxy group, aryloxy group, silyloxy group, acyloxy group, carbamoyloxy group, heterocyclic oxy group, alkoxycarbonyloxy group, aryloxycarbonyloxy group, alkylamino group, arylamino group, heterocyclic amino group, acylamino group, ureido group, sulfamoylamino group, alkoxycarbonylamino group, aryloxycarbonylamino group, alkyl- or arylsulfonylamino group, aryloxycarbonylamino group, nitro group, alkyl- or arylthio group, alkyl- or aryl-sulfonyl group, alkyl- or arylsulfinyl group, sulfamoyl group, sulfo group or heterocyclic thio group, which may be substituted further, or R¹ and R³ or R³ and R⁴ may be coupled to form a 5- or 6-membered ring;
a and e each independently represents an alkyl group, alkoxy group or halogen atom which may be substituted further; and
b, c and d each independently has the same meaning as R¹ and R², or a and b or e and d may be fused each other.

6. An inkjet recording ink composition comprising a coloring composition according to claim 1.

7. An inkjet recording method, which comprises:
forming an image on a receiver material, which comprises a support; and an ink absorbing layer containing an inorganic white pigment on the support, by utilizing an inkjet recording ink composition according to claim 6.
